(19) United States
(12) Patent Application Publication
(10) Pub. No.: US 2021/0097904 A1
(43) Pub. Date: Apr. 1, 2021

(54) ILLUMINATED MARKERS FOR VEHICLE IDENTIFICATION AND MONITORING AND RELATED SYSTEMS AND METHODS

(71) Applicant: Quantronix, Inc., Farmington, UT (US)

(72) Inventors: Brandon M. Taylor, Kaysville, UT (US); Robert L. Kennington, Kaysville, UT (US); Heath A. Pritchett, Kaysville, UT (US); Justin G. Norman, West Point, UT (US); Rüdiger Elben, Alsdorf (DE)

(21) Appl. No.: 15/733,379

(22) PCT Filed: Jan. 23, 2019
(86) PCT No.: PCT/US2019/014751

§ 371 Date: Jul. 16, 2020

Related U.S. Application Data
(60) Provisional application No. 62/621,861, filed on Jan. 25, 2018.

(51) Int. Cl. G09F 13/04; B60Q 1/56; G08G 1/00; G09F 7/18; G09F 21/04; G06K 19/07

(52) U.S. Cl. CPC G09F 13/0404; B60Q 1/56; G08G 1/20; G06K 19/0728; G09F 13/0413; G09F 21/048; G09F 7/18

(57) ABSTRACT

A marker system for a vehicle comprises a marker structure bearing an augmented reality (AR) code visible on a surface thereof, and an illumination source configured and positioned to provide sufficient contrast between the AR code and adjacent portion of the marker structure at the surface to enable a camera aimed at the surface to detect the AR for recognition thereof. Related systems and methods are also disclosed.

### CROSS-REFERENCE TO RELATED APPLICATIONS

This application is a national phase entry under 35 U.S.C. § 371 of International Patent Application PCT/US2019/014751, filed Jan. 23, 2019, designating the United States of America and published in English as International Patent Publication WO 2019/147673 A1 on Aug. 1, 2019, which claims the benefit under Article 8 of the Patent Cooperation Treaty to U.S. Provisional Patent Application Ser. No. 62/621,861, filed Jan. 25, 2018, for “Illuminated Markers for Vehicle Identification and Monitoring and Related Systems and Methods.”

### TECHNICAL FIELD

Embodiments of the present disclosure relate to vehicle identification and monitoring using illuminated markers. More particularly, embodiments of the present disclosure relate to identification and monitoring of vehicles, such as forklifts and pallet jacks, employed in freight-handling and warehouse environments.

### BACKGROUND

Shipment and storage of articles in commerce, which will be referred hereto as “freight” for simplicity, has become ever more automated over time. Such automation has been stimulated in major part by the recognition of shippers such as Federal Express, United Parcel Service and other courier and delivery services, as well as commercial carriers for palletized freight, that it is often the volume, rather than the weight, of an article or group of articles which should dictate the charge for shipment. As a result, the industry has developed a fictitious parameter, in the form of a so-called dimensional weight factor (DWF), commonly termed “dim weight,” by which articles in commerce are characterized and charges are levied.

Dim weight is based on length (L) times width (W) times height (H) in inches divided by a standard agency or association-recognized divisor or conversion factor, commonly 139 (L×W×H) 139) for international shipments and 166 (L×W×H) 166) for domestic U.S. shipments. The “139” and “166” divisors or conversion factors have been recognized and adopted by the International Air Transport Association (I.A.T.A.). Even if an article, package or group of articles or packages such as is encountered with palletized freight is of irregular configuration, the “dim weight,” using the longest measurement each of length, width, and height, is still utilized for billing purposes. The volume computed by multiplication of article (or group) length times width times height may hereinafter be termed the “cubic volume,” “spatial volume,” or simply the “cube” of the article.

The measurements of the articles shipped are also critical so that the carrier can accurately determine the number of trucks, trailers, or other vehicles which will be required to transport goods to their destinations and so both customers and carriers can accurately estimate their warehousing and other storage needs. In addition, article weight and measurements may also be used to determine and predict weight and balance for transport vehicles, ships and aircraft and to dictate the loading sequence for objects by weight and dimensions for maximum safety and efficiency.

A variety of technologies has been developed in the past two decades to automate, or at least partially automate, dimensioning of packages and other objects. Conveyorized systems enable dimensioning of hundreds to thousands of packages per hour. Systems for dimensioning of palletized freight have, until recently, required that the pallet with freight be stationary as dimensioning takes place, greatly reducing throughput in the facility using the dimensioning system. Recently, however, systems for dimensioning palletized freight in motion, as for example in transit on a forklift, have been developed. Such systems include the DynaDim™ PF 1200 by Northrop Grumman through their AOA Xinetics subsidiary, as well as a product identified as the CUBISCAN® 1200-AKL DriveThru from Quantronix, Inc. in the United States and as the APACHE™ Flying Forklift from AKL-tec in Europe. It is also believed that Mettler Toledo has developed an in-motion palletized freight dimensioning system.

One feature common to in-motion pallet dimensioning, regardless of the technology employed, is the need to identify the forklift (also sometimes characterized as a “lift truck”) or pallet jack (also sometimes characterized as a “pallet truck”) carrying the freight, as well as the need to determine speed through the measuring zone and ensure that the path of the palletized freight through the measuring zone is reasonably straight and does not deviate more than a certain degree from an optimum path through the measuring zone. Attempts have been made to identify and monitor the pallet-carrying vehicle with one or more overhead cameras of an in-motion dimensioning system through the use of inactive identifiers as fiducial reference points for a vehicle, such as marker cards with indicia mounted to the top of a forklift, as well as fiducial markers on the top or sides of the vehicle. Such identifiers must remain clearly visible to a camera or cameras employed in the dimensioning system throughout the measuring zone, or false dimensions or an error signal results. However, warehouses and other freight-handling environments, including unenclosed areas, are susceptible to significant and irregular lighting intensity variations from conventional overhead lighting arrangements, light angle variations from differing sun and lighting angles and reflected light, shadows and dust associated with such environments. As a result, in-motion palletized freight dimensioning may, at present, lack requisite reliability for widespread adoption by industry for use in all contemplated environments.

### BRIEF SUMMARY

In some embodiments, a marker system for a vehicle comprises a marker structure bearing an augmented reality (AR) code visible on a surface thereof, and an illumination source configured and positioned to provide sufficient contrast between the AR code and adjacent portion of the marker structure at the surface to enable a camera aimed at the surface to detect the AR for recognition thereof.

In other embodiments, a vehicle tracking system comprises a marker structure for mounting to a vehicle, and comprising an upward-facing, inverted augmented reality (AR) code on a surface of the marker structure, an illumination source to illuminate the inverted augmented reality (AR) code, and a Bluetooth transceiver. The system further comprises at least one downwardly aimed camera located above a potential path of a vehicle to which the marker structure is mounted, and comprising a power source from which power for the illumination source is to be supplied, and at least one Bluetooth transceiver associated with the at least one downwardly aimed camera and identifiable by a Device Name recognizable by the Bluetooth transceiver of the marker structure.

In further embodiments, a method for identifying and tracking a vehicle comprises illuminating an inverted augmented reality (AR) code to be visible from above a vehicle bearing the inverted augmented reality (AR) code, and moving the vehicle through a field of view of a downwardly facing camera configured to detect a position and orientation of the illuminated inverted augmented reality (AR) code when the illuminated inverted augmented reality (AR) code is within the field of view.

In still other embodiments, a marker system for a vehicle comprises:
a marker structure bearing an augmented reality (AR) code visible on a surface thereof and
an illumination source configured and positioned to provide sufficient contrast between the augmented reality (AR) code and adjacent portions of the marker structure at the surface to enable a camera aimed at the surface to detect the augmented reality (AR) code for recognition thereof.

In yet further embodiments, a vehicle tracking system comprises a marker structure for mounting to a vehicle and comprising an upward-facing, inverted augmented reality (AR) code on a surface of the marker structure, an illumination source to illuminate the inverted augmented reality (AR) code; and a Bluetooth transceiver. The vehicle tracking system also comprises at least one downwardly aimed camera located above a potential path of a vehicle to which the marker structure is mounted, a power source from which power for the illumination source is to be supplied and at least one Bluetooth transceiver associated with the at least one downwardly aimed camera and identifiable by a Device Name recognizable by the Bluetooth transceiver of the marker structure.

In still further embodiments, a method for identifying and tracking a vehicle comprises illuminating an inverted augmented reality (AR) code to be visible from above a vehicle bearing the inverted augmented reality (AR) code, moving the vehicle through a field of view of a downwardly facing camera configured to detect a position and orientation of the illuminated inverted augmented reality (AR) code when the illuminated inverted augmented reality (AR) code is within the field of view.

### BRIEF DESCRIPTION OF THE DRAWINGS

FIG. 1 is a perspective view of a forklift configured for carrying a load of palletized freight;

FIG. 2 is a perspective view of a pallet jack configured for carrying a load of palletized freight;

FIG. 3A is a perspective view of an embodiment of an active marker suitable for mounting to a forklift or a pallet jack, according to the disclosure, FIG. 3B is a top elevation of the active marker of FIG. 3A, and FIG. 3C is a side elevation of the active marker of FIG. 3A;

FIG. 4 is a schematic block diagram of an embodiment of an active marker according to the disclosure;

FIG. 5A is a side schematic side sectional elevation of another embodiment of an active marker suitable for mounting to a forklift or a pallet jack, according to the disclosure, and FIG. 5B is a schematic partial top elevation of the embodiment of FIG. 5A;

FIG. 6 is a schematic wiring diagram for embodiments of an active marker according to the disclosure;

FIG. 7 is a schematic representation of an overhead lighting configuration in combination with a passive marker suitable for mounting to a forklift or a pallet jack, according to the disclosure;

FIGS. 8A, 8B and 8C are schematic representations of arrangements of Bluetooth transmitters for use with markers according to the disclosure for signal communication with a marker mounted on a vehicle passing through the measuring zone of an in-motion palletized freight dimensioning system;

FIG. 9 is a top elevation of an in-motion dimensioning system overhead framework to which a camera for acquiring and tracking a vehicle-mounted marker according to embodiments of the disclosure is mounted; and

FIG. 10 is a flowchart of operation of an active marker of the disclosure as controlled by software of the marker.

### DETAILED DESCRIPTION

The illustrations presented herein are not actual views of any particular active marker, vehicle tracking system or method of identifying and tracking a vehicle, but are merely idealized representations which are employed to describe embodiments of the present disclosure.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles between surfaces that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the terms “longitudinal,” “vertical,” “lateral,” and “horizontal” are in reference to a major plane of a substrate (e.g., base material, base structure, base construction, etc.) in or on which one or more structures and/or features are formed and are not necessarily defined by earth's gravitational field. A “lateral” or “horizontal” direction is a direction that is substantially parallel to the major plane of the substrate, while a “longitudinal” or “vertical” direction is a direction that is substantially perpendicular to the major plane of the substrate. The major plane of the substrate is defined by a surface of the substrate having a relatively large area compared to other surfaces of the substrate.

As used herein, spatially relative terms, such as “beneath,” “below,” “lower,” “bottom,” “above,” “over,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “over” or “above” or “on” or “on top of” other elements or features would then be oriented “below” or “beneath” or “under” or “on bottom of” the other elements or features. Thus, the term “over” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the terms “configured” and “configuration” refer to a size, shape, material composition, orientation, and arrangement of one or more of at least one structure and at least one apparatus facilitating operation of one or more of the structure and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

As used herein, the terms “layer” and “film” mean and include a level, sheet or coating of material residing on a structure, which level or coating may be continuous or discontinuous between portions of the material, and which may be conformal or non-conformal, unless otherwise indicated.

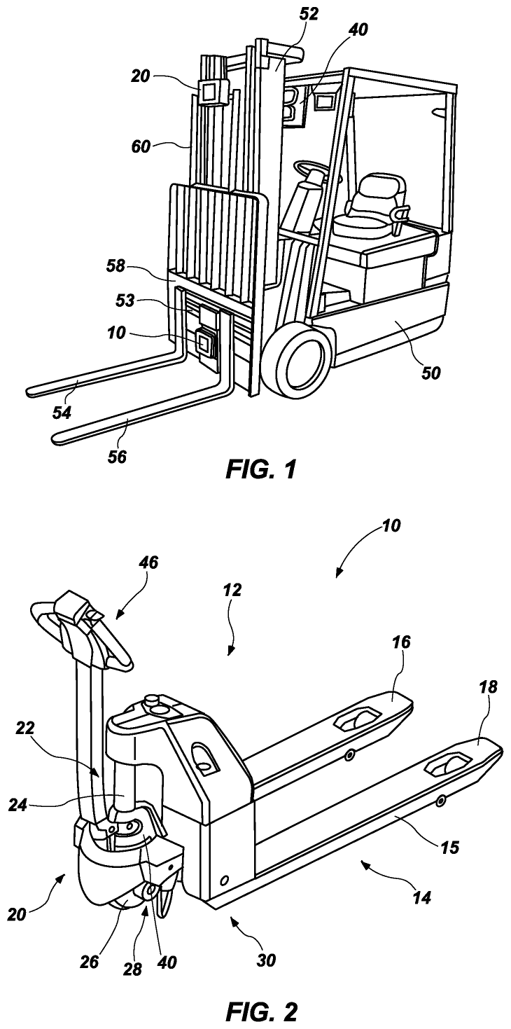

FIG. 1 and FIG. 2 are, respectively, illustrations of examples of a forklift and a pallet jack with which an active marker according to an embodiment of the disclosure may be employed. FIG. 1 is taken from U.S. Patent Application Publication US 2011/0095871 and FIG. 2 is taken from U.S. Pat. No. 8,833,736, the disclosure of each of which is incorporated herein in its entirety by this reference. An active marker in accordance with an embodiment of the disclosure may be mounted to either vehicle, the only requirement for placement being that a view of the marker from above remains unobstructed throughout the path the vehicle traverses as it is being monitored by an overhead camera.

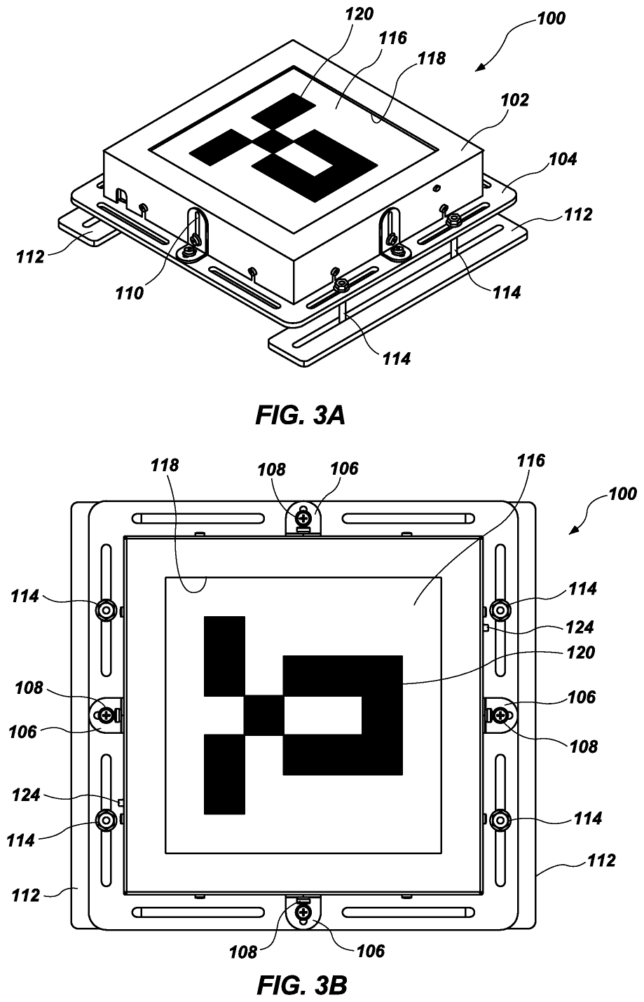

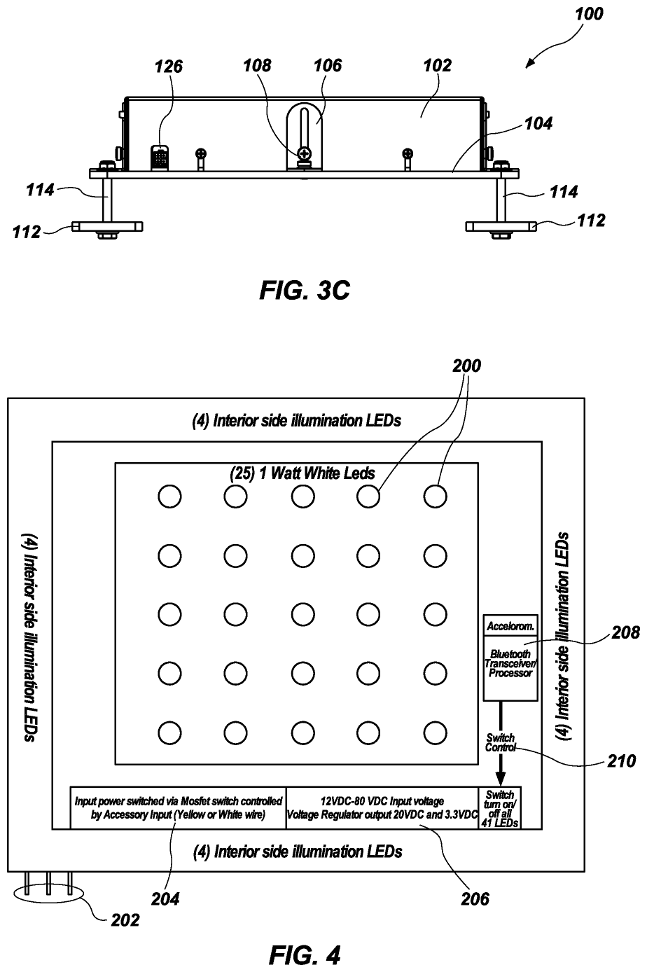

FIGS. 3A, 3B and 3C depict an embodiment of active marker 100, wherein an outer housing 102 is mounted to a base 104 by brackets 106 and bolt and nut assemblies 108 on each of the four sides thereof. Notably, outer housing may be slidably raised above base via channels 110 in brackets 106, Base 104 may, in turn, be secured to a forklift or a pallet jack by mounting brackets 112 on opposing sides of base 104, base 104 and mounting brackets 112 being clamped together with a portion of a forklift or pallet jack structure between them by bolt and nut assemblies 114. Of course, other conventional techniques for mounting an active marker to a vehicle are known to those of ordinary skill in the art and may be implemented easily. Outer housing 102 and base 104 may, for example, be formed of sheet metal. A transparent sheet such as acrylic sheet 116 is located within and extends laterally beyond aperture 118 in the top of outer housing 102, and may be sealed with housing via a neoprene gasket (not shown). Below acrylic sheet 116 is located a clear sheet such as an acrylic sheet having an inverted augmented reality (AR) code 120 printed thereon, AR code 120 being visible through transparent acrylic sheet 116 and backlit from within housing, as will be described below. The term “inverted” is used to describe an AR code wherein the code symbol is opaque and, optionally, black and the background is light, whereas a conventional AR code employs a white code symbol and black background. The inverted code permits more light to emanate from active marker 100.

The AR code employed has been defined and developed in the ArUco project (https://www.uco.es/investiga/grupos/ava/node/26). This code, in inverted form as employed in embodiments of the disclosure, offers a highly sophisticated and stable approach to pattern recognition for determining a position and orientation of something associated with an image. The active marker of embodiments of the disclosure, in combination with an intrinsic camera calibration for the camera viewing the active marker, enables vehicle position determination with a precision of about 2 mm.

Below the clear acrylic sheet with the AR code 120 is a translucent diffuser sheet (not shown). On suitable diffuser sheet is a Lumen XT LC7 polycarbonate material. The use of the inverted AR code, in combination with the diffused light provided by the diffuser sheet overcomes variations in lighting conditions such as uneven overhead lighting, angled sunlight through windows, direct sunlight, light entering a structure intermittently as entry doors open and close, reflected light, and dust in the air. As shown in FIG. 3B, green translucent lenses 124, each placed in an aperture through opposing sides of outer housing 102, may be used to visually discern that the active marker 100 is illuminated. Power connection 126 (FIG. 3C), for receiving power for active marker 100 from an external source, extends through one side of outer housing 102.

Referring now to FIG. 4, active marker 10 contains within the volume defined by outer housing 102 and base 104 (see FIGS. 3A through 3C) an illumination source in the form of a number of white light-emitting diodes 200 (LEDs), for example 1 watt LEDs. By way of example only, twenty-five LEDs 200 may be disposed in a five-by-five LED array in the center of the volume, whereas four LEDs 200 (not shown) may be aimed outwardly toward the interior of each of the four sidewalls of outer housing 102. The interior, and specifically the interior of the sidewalls, is painted white, preferably with a highly reflective white paint. One suitable paint is Cardinal powder coat #T009-WH12. Power inputs 202 via power connection 126 (FIG. 3C) provide power to active marker 100, and input power may be switched via a Mosfet switch controlled by an Accessory Input, as noted in block 204. Input voltage may range from 12 volts DC to 80 volts DC (to accommodate different forklift power systems), and a voltage regulator of active marker 100 outputs 20 volts DC and 3.3 volts DC as noted in block 206. Activation of the LEDs 200 of active marker 100 is controlled by a Bluetooth transceiver/processor module and an accelerometer as noted in block 208, which operate switch control 210 as will be explained below. The 20 volt output of the voltage regulator is used to power the LEDs 200, while the 3.3 volt output is used to power the Bluetooth transceiver/processor module and accelerometer of block 208, as further described below.

One suitable micro-electronic-mechanical-system (MEMS) accelerometer is offered by ST Microelectronics, part number LIS3DHTR. Other suitable MEMS accelerometers are also commercially available. The accelerometer is used to measure g forces so, when a g force is greater than the programed threshold in two axes then a flag is set indicating that criteria has been met for turning on the LED's. In other words, at least one of the X or Y axis (horizontal axes) output and the Z axis (vertical) output of the accelerometer must be greater or equal to the programmed threshold for the criteria to be met. The Z axis is used for vibration detection. For different accelerometer sensitivities, the required g force detection thresholds are different. After a forklift or pallet jack reaches a certain speed, the g force will start levelling out.

| | |
|---|---|
| For a sensitive accelerometer the formula is | (X or Y) >= 0.05 g and Z >= 1.05 g |
| For medium sensitivity | (X or Y) >= 0.10 g and Z >= 1.10 g |
| For low sensitivity | (X or Y) >= 0.15 g and Z >= 1.15 g |
| Z is always greater because gravity is 1 g | |

Of course, the g-force parameters may be varied to accommodate different vehicle threshold speeds, or the formula revised for particular use conditions.

In lieu of an accelerometer, it is also contemplated that a second device in the form of an ultra-high frequency RFID tag may be incorporated into active marker 100 to provide a second input to active marker 100 that it is within range and approaching a dimensioning zone, in addition to a received Bluetooth signal, to initiate the LEDs 200. Such RFID tags may have a range of as great as 12 meters, but may have to have associated shielding to prevent interference. Other radiofrequency signal protocols may also be used as a second dimensioning zone proximity verification input. However, use of radiofrequency approaches for a second input would, in many instances, require a timer to disable active marker 100 within a relatively short period of time to avoid protracted activation of active marker 100 on a stationary vehicle within range and thus prevent draining the vehicle electrical power source.

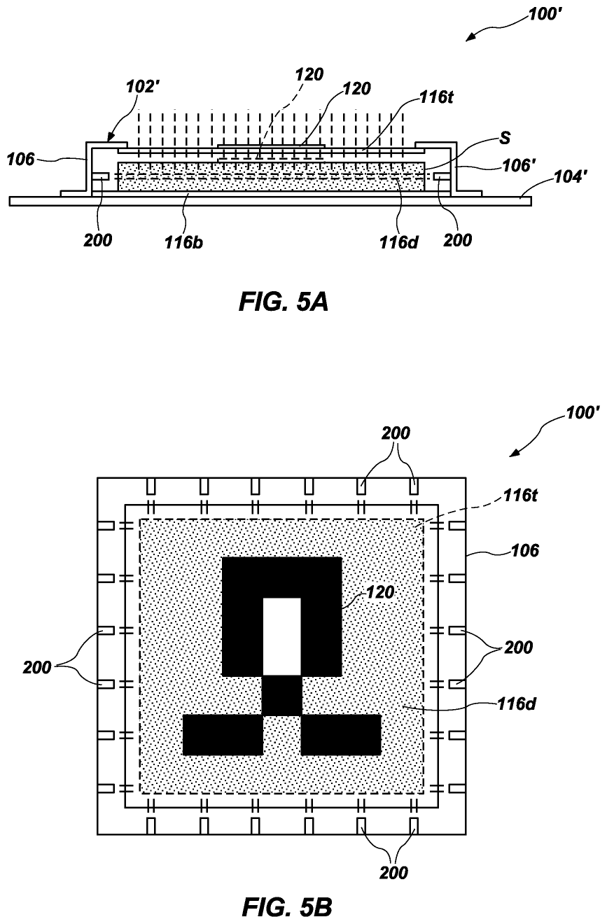

FIGS. 5A and 5B depict another embodiment of active marker 100′, which may be somewhat more compact vertically than active marker 100. In the case of active marker 100′, a base 104′ supports a rectangular sheet 116d containing colorless light diffusing particles p and having polished side surfaces S. Sheet 116d may comprise, for example, ACRYLITE® LED or ACRYLITE® LED (EndLighten), available from Evonik Performance Materials GmbH of Essen, Germany. Linear arrays of LEDs 200 carried by brackets 106′ and forming housing 102′ attached to base 104′ are arranged to emit light inwardly and parallel to the plane of sheet 116d as shown in broken lines into two or more sides of sheet 116d. Fewer LEDs 200 may be required for active marker 100′ than in the case of active marker 100, although LEDs of a higher luminous power, and thus greater wattage, may be required. Another sheet 116t of transparent material, for example an acrylic material without the light diffusing particles and having an inverted AR code 120 printed thereon may be placed above acrylic sheet 116d in parallel, spaced relationship thereto, and sealed at its edges to outer housing 102′. Optionally, the inverted AR code 120 may be printed on the outer surface of acrylic sheet 116d as shown in broken lines, and acrylic sheet 116t eliminated. Below acrylic sheet 116d may be a reflective backing sheet 116b of, for example, polystyrene, ACRYLITE® FF WT 020, or White Optics F23. Optionally, a mirror-like reflective sheet, such as ACRYLITE® Reflections, may be employed. Alternatively, the lower surface of acrylic sheet 116d may be coated with a reflective or gloss white coating. Active marker 100′ may be powered, and activated and deactivated as described above with respect to active marker 100, using Bluetooth technology in combination with an accelerometer, RFID tag or the use of other radiofrequency protocols. Active marker 100′ may exhibit a slimmer enclosure than active marker 100, and fabrication costs may be less.

In use, activation of the linear arrays of LEDs 200 causes light to enter the sides of acrylic sheet 116d through the polished side surfaces thereof in a direction parallel to the major plane of acrylic sheet 116d, as shown in broken lines. The light diffusing particles embedded in the acrylic material redirect the light from LEDs 200 to a direction substantially perpendicular to the major plane, and thus the surface, of acrylic sheet 116d opposite reflective backing sheet 116b, to illuminate the surface of acrylic sheet 116t surrounding AR code 120. Light from LEDs 200 is also redirected into reflective backing sheet 116b by the light diffusing particles, and a portion of the redirected light is reflected back through acrylic sheet 116d and out of the opposite surface of acrylic sheet 116d and through transparent acrylic sheet 116t.

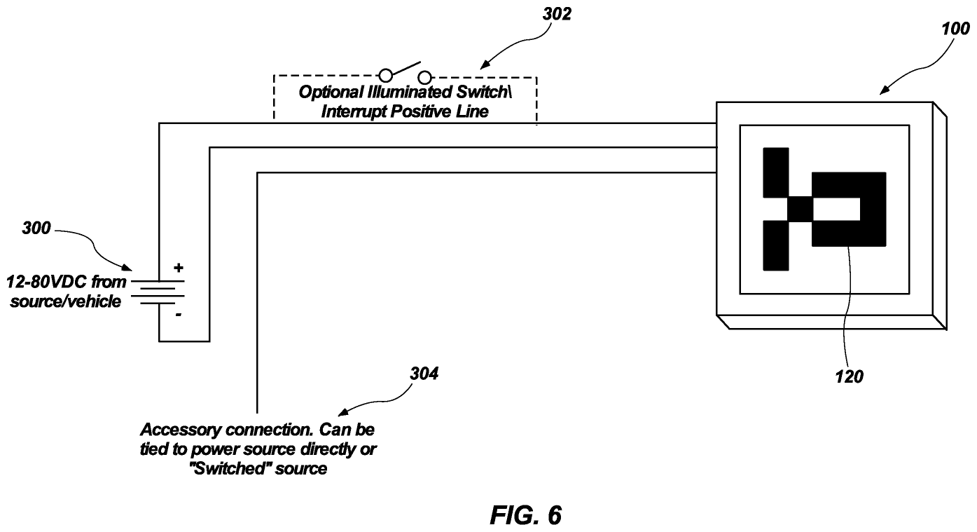

FIG. 6 is a schematic depiction of a wiring diagram suitable for use with active marker 100 or active marker 100′. As noted above and at 300, power may be supplied from a source carried by the forklift. An additional, separate switch may also be optionally placed in the positive power line as noted at 302. This switch may be used as a second device to power on the LEDs 200 of active marker 100 or 100′ in combination with the Bluetooth signal or in lieu of the combination of accelerometer output and Bluetooth signal for some installations. A jumper on the circuit board of active marker 100 may be used to place active marker 100 or 100′ in such manual mode. An accessory connection can be tied to the power source directly, or via a switch, as noted at 304.

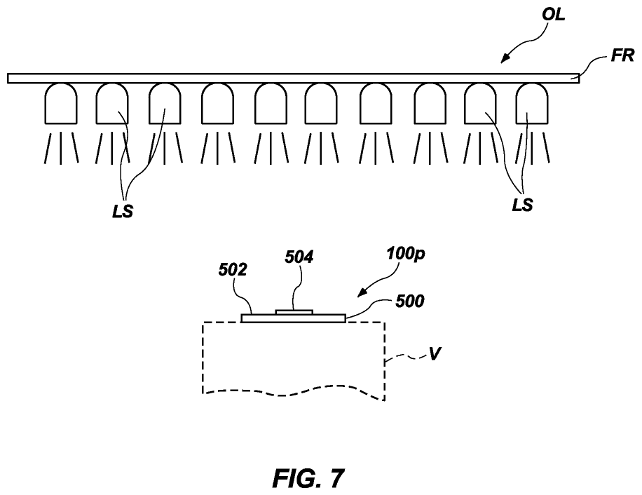

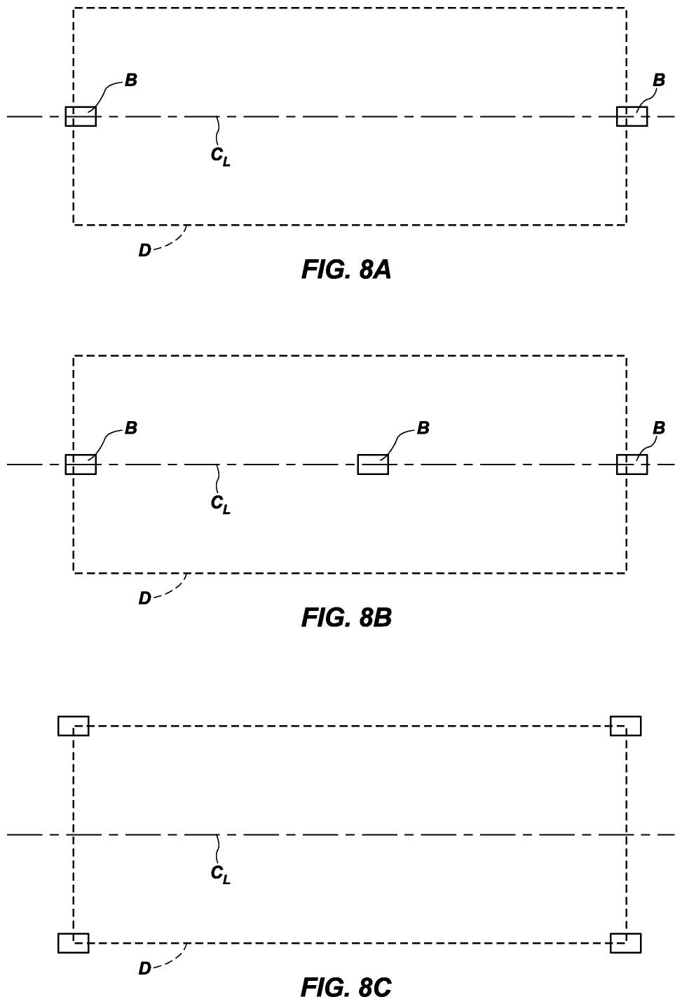

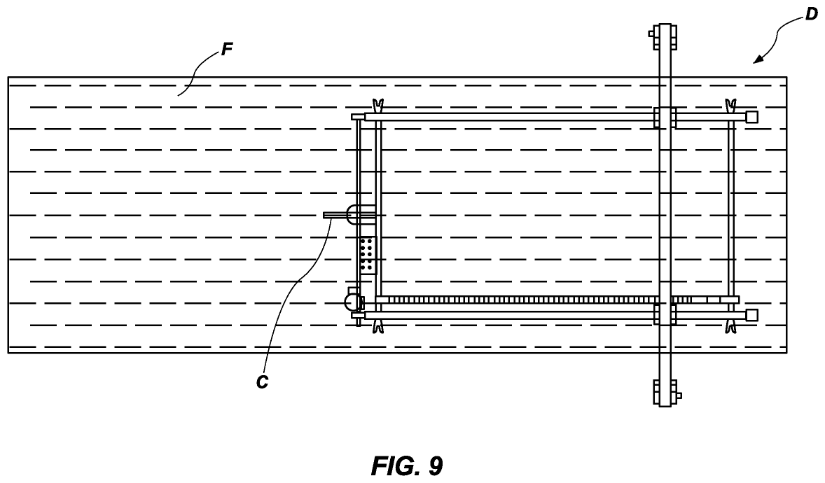

FIG. 7 is a schematic representation of an embodiment of an overhead light system OL in combination with a passive marker 100p suitable for mounting to a forklift or a pallet jack, according to the disclosure. In such a configuration, a substrate 500 such as a metal, plastic or wood material and configured, for example, in a rectangular shape for a body of passive marker 100p may be provided with a highly reflective surface 502. An opaque, inverted AR code 504 may then be adhered to the reflective surface 502. Passive marker 100p is secured to a forklift, pallet jack or other vehicle V (portion thereof shown in broken lines) with reflective surface 502 facing upward and parallel to a horizontal plane in a location unobstructed from a downward viewpoint. A light source, such as an overhead light system OL, may be placed over or incorporated in dimensioning zone D described below with respect to FIGS. 8A, 8B and 8C. Overhead light system OL may comprise any suitable lighting technology, for example LED, Halogen, or sodium vapor and comprise an array of downwardly-aimed light sources LS placed in rows and columns and suspended from a framework FR secured, for example, to a ceiling structure of a building, light sources LS in the form of flood or spot lights, to cover at least a portion, e.g., a portion associated with a location of a camera C of dimensioning zone D, and specifically within a field of focus F of camera C, as described below with respect to FIG. 9. As vehicle V moves under overhead light system OL with light sources LS activated, light from light sources LS is reflected from reflective surface 502 of substrate 500, outlining augmented reality (AR) code 504 for detection by camera C and recognition by processor of dimensioning system D as an identifier for vehicle V and, thus, the pallet or payload carried thereby. While the cost of overhead light system OL may be significant, the overall cost of the combination of same in use with a number of passive markers 100p may be less than in the case of active markers. To avoid the issue of excessive illumination and glare in the visible light spectrum by light sufficient for camera C to recognize the AR code of a passive marker 100p, infra red (IR) light sources LS may be employed.

FIGS. 8A, 8B and 8C schematically illustrate three alternative location formats for one or more Bluetooth transmitters which may be used to initiate and ensure continued activation of active marker 100 or 100′ when a forklift or other vehicle to which active marker is mounted approaches and passes through an entirety of a dimensioning zone of an in-motion pallet dimensioning system as referenced above, while active marker 100 or 100′ is tracked by at least one overhead camera of an in-motion palletized freight dimensioning system, aimed downwardly over the dimensioning zone. The at least one camera is configured to identify the specific active marker 100 or 100′, and the position and orientation of the active marker and, thus, of the vehicle, as it passes through the field of view of the camera. Suitable Bluetooth transmitters include, for example, a Bluetooth transceiver, Part Number ESP-32, offered by Espressif Systems. The same Bluetooth transceiver may be employed in active marker 100 or 100′. Another manufacturer offering suitable Bluetooth transmitters is Nordic Semiconductor. Bluetooth Low Energy may be employed for the radiofrequency signal, to offer reduced power consumption and cost in comparison to Classic Bluetooth, while maintaining a similar range. One suitable camera is a uEye IDS camera, a progressive scan monochrome camera. Other suitable cameras are available from Sony, Basler, Hitachi and others.

FIG. 8A depicts placement of Bluetooth transmitters B at the beginning and end of dimensioning zone D, shown in broken lines. Bluetooth transmitters B may be placed along a centerline CL of dimensioning zone D, indicating a preferred path for a vehicle carrying a pallet through dimensioning zone D. FIG. 8B depicts placement of Bluetooth transmitters B at the beginning, middle and end of dimensioning zone D, shown in broken lines. Bluetooth transmitters B may be placed along a centerline CL of dimensioning zone D, indicating a preferred path for a vehicle carrying a pallet through dimensioning zone D. FIG. 8C depicts placement of four Bluetooth transmitters B, one proximate each corner of dimensioning zone D. Such a placement as shown in FIG. 8C may accommodate wider lateral and angular deviations from centerline CL of a vehicle carrying a pallet through dimensioning zone D. Of course, a single Bluetooth transmitter B may be employed if the longitudinal extent of the dimensioning zone required to accommodate sensors and/or cameras used by the dimensioning system is relatively short, and the transmitter may be a Class 1 Bluetooth device with 100 mW transmission power. Active marker 100 or active marker 100′ may also be equipped with an external antenna for additional sensitivity. As the Bluetooth frequency is 2483.5 MHz, for best reception an antenna would be matched to this frequency. If tuned to ¼ wavelength, which is known to those of ordinary skill in the art, an antenna of 1.1881 in. (3.0178 cm) length would perform well. It is also contemplated when multiple Bluetooth transmitters B may be employed, the accelerometer may be omitted. Bluetooth transmitters having antennas configured to enhance the directional orientation of the Bluetooth signal may be used to prevent inadvertent activation of active marker 100 in the absence of an accelerometer.

FIG. 9 illustrates an example of camera placement for the aforementioned IDS camera C, with the field of view F of camera C illustrates in the rectangular shaded area indicated by broken lines. As may be appreciated from a view of FIG. 8, camera C may acquire and track the position and orientation of an active marker 100 or 100′ or a passive marker 100p mounted to a forklift, pallet jack or other vehicle well before the vehicle enters a dimensioning zone D as indicated by the overhead framework F to which camera C is mounted.

It is significant to the operation of active marker 100 or 100′ or of passive marker 100p that the marker illumination only be initiated when the vehicle to which it is mounted is in motion and within range of the one or more Bluetooth transmitters associated with dimensioning zone D. Specifically, activation of active markers for extended periods of time will drain the power source of the vehicle excessively to the point of inoperability. Thus, not only must the Bluetooth transceiver/processor receive a signal from the one or more Bluetooth transmitters B, but the accelerometer associated with the Bluetooth transceiver/processor must provide a trigger signal indicative of a minimum vehicle speed. Premature and overly extended illumination of passive markers not only requires undesirable power usage by the overhead lighting system, but (if the light is not in the IR spectrum) creates undesirable glare in the operating area of the forklift, pallet jack or other vehicle to which the passive marker is mounted.

Active marker 100 or 100′ or passive marker 100p may be used to identify the vehicle carrying a pallet being dimensioned, so that the AR code of the vehicle may be correlated with a bar code, waybill or other identification indicia, for example an RFID tag, associated with the pallet. In addition, active marker 100 or 100′ or passive marker 100p may be used to provide enhanced reliability to the in-motion dimensioning system with which it is used. Specifically, since active marker 100 or 100′ in operation, or passive marker 100p when illuminated, provides a highly visible reference point, as noted above a camera or cameras overhead and aimed downwardly may be used to monitor operating parameters of the vehicle carrying the pallet. For example, active marker 100 or 100′ or passive marker 100p may be used to detect or confirm vehicle speed and constant rate of speed, both of which are significant to accurate pallet dimensional determination in the direction of vehicle travel. In addition, deviations from a preferred path through the dimensioning zone D beyond certain software-correctable limits may be detected responsive to changes in orientation of the AR code of active marker 100 or 100′ or illuminated passive marker 100p, such deviations include unacceptable yaw angle (for example, >10°) as well as repeated deviations in multiple directions back and forth (i.e., a sinuous path) while traversing the dimensioning zone D. Excessive vehicle speed through dimensioning zone D may also be detected and used to identify erroneous dimensioning runs as well as safety issues.

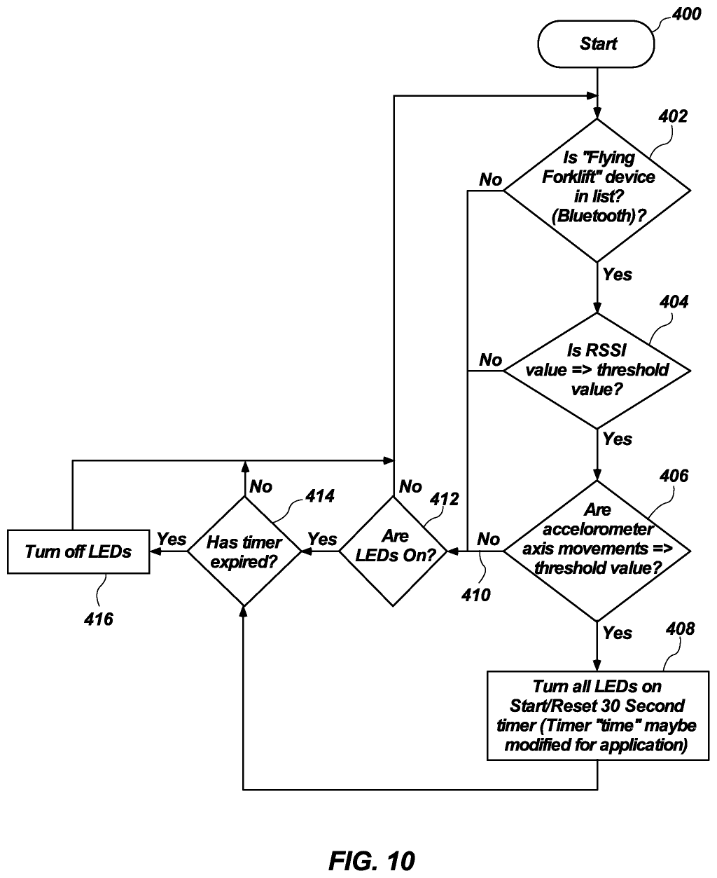

FIG. 10 is a flowchart of the software incorporated in active marker 100.

Bluetooth Transceiver/Processor of active marker 100 or 100′ is activated at 400, and searches for an appropriate Bluetooth Device Name, for example “Flying Forklift,” associated with the Bluetooth transmitter or transmitters of the in-motion dimensioning system to be used to dimension the palletized freight carried by the vehicle bearing active marker 100 or 100′. If more than one Bluetooth transmitter is installed in the system as noted above, each transmitter would have a unique Device Name (e.g., “Flying Forklift 1,” “Flying Forklift 2,” etc.) recognizable by programmed Bluetooth Transceiver/Processor of active marker 100 or 100′. As noted at 404, the relative received signal strength indication (RSSI) at Bluetooth Transceiver/Processor of active marker 100 must be above a predetermined threshold value and, if not, active marker 100 or 100′ will not initiate. If so, then the axis movement of the accelerometer is queried at 406 and, if above a threshold value indicating adequate vehicle speed, LEDs are then turned on at 408 and an optional timer for duration of LED activation may be started or reset. The threshold may be varied, if desired, through the use of a dip switch to enable different threshold values. If the accelerometer output is not indicative of a speed above the set threshold value at 410, whether or not LEDs are turned on is then queried at 412 and, if LEDs are turned on, whether the timer has expired is next queried at 414. If so, the LEDs are turned off at 416, if not, they remain on.

In the case of an overhead lighting system OL in combination with a passive marker 100p, the process flow may be similar to that described above in FIG. 10. Bluetooth Transceiver/Processor of passive marker 100p is activated, and searches for an appropriate Bluetooth Device Name, for example “Flying Forklift,” associated with the Bluetooth transmitter or transmitters of the in-motion dimensioning system to be used to dimension the palletized freight carried by the vehicle bearing passive marker 100p. If more than one Bluetooth transmitter is installed in the system as noted above, each transmitter would have a unique Device Name (e.g., “Flying Forklift 1,” “Flying Forklift 2,” etc.) recognizable by programmed Bluetooth Transceiver/Processor of passive marker 100p. As noted above, the relative received signal strength indication (RSSI) at Bluetooth Transceiver/Processor of passive marker 100p must be above a predetermined threshold value and, if not, Bluetooth Transceiver/Processor of passive marker 100p will not initiate in a transmit mode. If so, then the axis movement of the accelerometer is queried and, if above a threshold value indicating adequate vehicle speed, Bluetooth Transceiver/Processor of passive marker 100p transmits to Bluetooth receiver or receivers of overhead light system OL to activate overhead light system OL, which activation may include an optional timer for a duration of activation of overhead light system OL to be started or reset. The threshold may be varied, if desired, through the use of a dip switch to enable different threshold values. If the accelerometer output is not indicative of a speed above the set threshold value, whether or not overhead light system OL is activated is then queried and, if lights thereof are turned on, whether the timer has expired is next queried. If so, the lights are turned off, if not, they remain on.

Alternatively, in the case of passive marker 100p, a Bluetooth Transceiver/Processor thereof may operate in a continuous or intermittent transmit mode, and Bluetooth receivers associated with dimensioning zone D may, when RSSI from the Bluetooth Transceiver/Processor is sufficient at the Bluetooth receivers, cause overhead light system OL to be activated. Such an arrangement may be implemented with a radiofrequency protocol, for example to also trigger a radiofrequency signal from overhead lighting system OL to confirm adequate proximity of passive marker 100p to dimensioning zone D using an RFID tag collocated with passive marker 100p on vehicle V before overhead light system OL is activated.

It should be appreciated that the use of an active marker according to embodiments of the disclosure may be used in a warehouse or other material-handling environment to track a vehicle having the active marker mounted thereon throughout its path using commercially available, high (sub-pixel) resolution cameras, in association with a pallet identifier such as a bar code, RFID tag, or waybill. Optimum transport paths may be determined and monitored, as well as speed and safety issues. An additional power source carried by the vehicle, for example a high-capacity rechargeable lithium ion battery, may be required if active marker is to be continuously illuminated.

It will also be recognized by those of ordinary skill in the art that, while visible light has been employed with the active marker as described herein, other wavelengths may also be employed and, in some situations may be required or desirable. For example, when mounted on a pallet jack, the active marker will be placed at a much lower elevation than on a forklift, as there is no driver cage or other framework. As a result, unless a mast is installed to elevate the active marker, the active marker would be placed below eye level, where a bright white light may be distracting to the operator, or even damaging to the eyes with protracted exposure. In such a situation, it is contemplated that infra-red (IR) lighting be employed in the active marker. IR cameras, as well as filters are commercially available, and provide adequate resolution. Similarly, if a passive marker is illuminated by an overhead lighting system, it may be desirable to employ IR lighting for safety and comfort of the operator of the vehicle to which the passive marker is mounted.

While particular embodiments of this disclosure have been shown and described, numerous variations and alternate embodiments will occur to those skilled in the art. Accordingly, it is intended that the invention only be limited in terms of the appended claims and their legal equivalents.

To more completely describe, without limitation, embodiments of the disclosure, a non-limiting set of numbered embodiment set forth below.

Embodiment 1: An active marker for a vehicle, comprising: a housing defining an interior volume, an upper surface of the housing comprising an aperture; a light-transmissive sheet bearing an augmented reality (AR) code mounted in the aperture; and an illumination source within the interior volume of the housing.

Embodiment 2: The active marker of Embodiment 1, wherein the augmented reality (AR) code is an inverted augmented reality (AR) code.

Embodiment 3: The active marker of Embodiment 1 or 2, further comprising a translucent diffuser sheet mounted in the aperture.

Embodiment 4: The active marker of Embodiment 1, 2 or 3, wherein the illumination source comprises LEDs, and further comprising: a Bluetooth transceiver/processor; and an accelerometer.

Embodiment 5: The active marker of Embodiment 4, further comprising: a voltage regulator for receiving and conditioning power for the LEDs, the Bluetooth transceiver/processor and the accelerometer from a voltage source external to the active marker.

Embodiment 6: The active marker of Embodiment 5, further comprising a vehicle to which the active marker is mounted, the vehicle comprising an electrical power source operably coupled to the active marker.

Embodiment 7: The active marker of Embodiment 4, wherein the Bluetooth transceiver/processor and the accelerometer, in combination, control initiation of the LEDs.

Embodiment 8: The active marker of Embodiment 4, wherein the Bluetooth transceiver/processor and the accelerometer, in combination, are configured to initiate the LEDs responsive to receipt of a Bluetooth signal recognizable by the Bluetooth transceiver/processor and an indication by the accelerometer of the active marker moving at a selected speed.

Embodiment 9: The active marker of Embodiment 1, wherein interior surfaces of the housing are glossy white, the illumination source comprises LEDs, and some of the LEDs are aimed toward interior sidewalls of the housing.

Embodiment 10: A vehicle tracking system, comprising: an active marker for mounting to a vehicle and comprising: an upward-facing, inverted augmented reality (AR) code on a light transmissive sheet; an illumination source below the inverted augmented reality (AR) code; a light diffuser between the illumination source and the inverted augmented reality (AR) code; and a Bluetooth receiver; at least one downwardly aimed camera located above a potential path of a vehicle to which the active marker is mounted and comprising a power source from which power for the illumination source is to be supplied; and at least one Bluetooth transmitter associated with the at least one downwardly aimed camera and identifiable by a Device Name recognizable by the Bluetooth receiver.

Embodiment 11: The vehicle tracking system of Embodiment 10, wherein the illumination source comprises LEDs, and the active marker further comprises a second device for providing an input signal which, in combination with a signal from the Bluetooth receiver, will cause the illumination source to initiate.

Embodiment 12: The vehicle tracking system of Embodiment 11, wherein the second device is selected from the group consisting of an accelerometer, an RFID tag, another radiofrequency device, and a manual switch.

Embodiment 13: The vehicle tracking system of Embodiment 11, wherein the second device comprises an accelerometer, and the Bluetooth receiver and the accelerometer, in combination, control initiation of the LEDs.

Embodiment 14: The vehicle tracking system of Embodiment 13, wherein the Bluetooth receiver and the accelerometer, in combination, are configured to initiate the LEDs responsive to receipt of the Bluetooth signal recognizable by the Bluetooth receiver and an indication by the accelerometer of the active marker moving at a selected speed.

Embodiment 15: The vehicle tracking system of Embodiment 10, further comprising a vehicle to which the active marker is mounted, the vehicle comprising an electrical power source operably coupled to a voltage regulator associated with the active marker for conditioning voltage from a power source for operation of the LEDs and the Bluetooth transmitter.

Embodiment 16: A method for identifying and tracking a vehicle, the method comprising: illuminating, from below, an inverted augmented reality (AR) code visible from above a vehicle to which a source of the illuminated inverted augmented reality (AR) code is mounted; moving the vehicle through a field of view of a downwardly facing camera configured to detect a position and orientation of the illuminated inverted augmented reality (AR) code when the illuminated inverted augmented reality (AR) code is within the field of view.

Embodiment 17: The method of Embodiment 16, further comprising illuminating the inverted augmented reality (AR) code in response to a Bluetooth receiver associated with the source receiving a signal from a recognizable Device Name in combination with another input.

Embodiment 18: The method of Embodiment 17, further comprising providing the another input from one of an accelerometer, an RFID tag, another radiofrequency device, and a manual switch.

Embodiment 19: The method of Embodiment 18, wherein the another input is provided by an accelerometer indication that a speed of the vehicle is at or above a threshold value.

Embodiment 20: The method of Embodiment 16, further comprising providing power to the source from a power source carried by the vehicle.

1. A marker system for a vehicle, comprising:
a marker structure bearing an augmented reality (AR) code visible on a surface thereof;
an illumination source carried by the marker structure on one side of the surface and configured and positioned to provide sufficient contrast between the augmented reality (AR) code and adjacent portions of the marker structure at the surface to enable a camera aimed at the surface from a side thereof opposite the illumination source to detect the augmented reality (AR) code for recognition thereof;
a Bluetooth transceiver associated with the marker structure; and
a second device for providing an input signal which, in combination with a signal from the Bluetooth transceiver of the marker structure, will cause the illumination source to initiate.

2. The marker system of claim 1, wherein the augmented reality (AR) code is an inverted augmented reality (AR) code.

3. The marker system of claim 1, wherein the marker structure comprises:
a housing defining an interior volume, an upper surface of the housing comprising an aperture;
the surface of the marker structure comprises a light-transmissive sheet bearing the AR code and mounted in the aperture; and
the illumination source is located within the interior volume of the housing.

4. The marker system of claim 3, further comprising a translucent diffuser sheet mounted in the housing below the light-transmissive sheet.

5. The marker system of claim 3, wherein the illumination source comprises LEDs, and
wherein the second device comprises at least one of an accelerometer, an RFID tag, another radiofrequency device, or a manual switch.

6. The marker system of claim 5, wherein at least some of the LEDs are arranged in an array under the light-transmissive sheet bearing the augmented reality (AR) code.

7. The marker system of claim 5, further comprising:
a voltage regulator for receiving and conditioning power for the LEDs, the Bluetooth transceiver and the second device from a voltage source external to the marker system.

8. The marker system of claim 5, wherein the second device comprises an accelerometer or an RFID tag and the Bluetooth transceiver and the accelerometer or the RFID tag, in combination, are configured to initiate the LEDs responsive to receipt of a Bluetooth signal recognizable by the Bluetooth transceiver and one of an indication by the accelerometer of the marker structure moving at a selected speed and an indication by the RFID tag that the marker structure is in proximity to a radiofrequency signal emitter.

9. The marker system of claim 3, wherein interior surfaces of the housing are glossy white, the illumination source comprises LEDs, and some of the LEDs are aimed toward interior sidewalls of the housing.

10. The marker system of claim 1, further comprising a vehicle to which the marker structure is mounted, the vehicle comprising an electrical power source operably coupled to at least the illumination source.

11. The marker system of claim 5, wherein:
the light-transmissive sheet comprises a sheet of transparent material containing light diffusing particles therein configured to redirect light entering a side of the sheet of transparent material substantially perpendicular to and out of a surface of the sheet of transparent material; and
at least some of the LEDs are arranged on two or more peripheral sides of the light-transmissive sheet aimed inwardly and parallel to a major plane of the light-transmissive sheet.

12. The marker system of claim 5, further comprising:
a sheet of transparent material containing light diffusing particles therein configured to redirect light entering a side of the sheet of transparent material substantially perpendicular to and out of a surface of the sheet, the sheet of transparent material beneath, spaced from and parallel to the light-transmissive sheet bearing the AR code; and
at least some of the LEDs are arranged on two or more peripheral sides of the sheet of transparent material aimed inwardly and parallel to a major plane thereof.

13. The marker system of claim 12, further comprising a material exhibiting a reflective surface beneath the sheet of transparent material containing light diffusing particles.

14. The marker system of claim 5, comprising:
at least one downwardly aimed camera located above a potential path of a vehicle to which the marker structure is mounted; and
at least one Bluetooth transceiver associated with the at least one downwardly aimed camera and identifiable by a Device Name recognizable by the Bluetooth transceiver of the marker structure.

15. The marker system of claim 14, wherein the Bluetooth transceiver of the marker structure and the second device, in combination, are configured to initiate the LEDs responsive to receipt of a signal from the Bluetooth transceiver associated with the at least one downwardly aimed camera and recognizable by the Bluetooth transceiver of the marker structure and a signal from the second device.

16. The marker system of claim 5, further comprising a vehicle to which the marker structure is mounted, the vehicle comprising an electrical power source operably coupled to a voltage regulator associated with the marker structure for conditioning voltage from a power source for operation of the LEDs and the Bluetooth transceiver of the marker structure.

17. A method for identifying and tracking a vehicle, the method comprising:
illuminating an inverted augmented reality (AR) code carried by a marker structure with an initiated illumination source of the marker structure below the inverted augmented reality (AR) code to cause the inverted augmented reality (AR) code to be visible from above a vehicle bearing the marker structure carrying the inverted augmented reality (AR) code;
initiating the illumination source being responsive to a signal from a Bluetooth transceiver and an input signal from a second device of the marker structure; and
moving the vehicle through a field of view of at least one downwardly facing camera configured to detect a position and orientation of the illuminated inverted augmented reality (AR) code when the illuminated inverted augmented reality (AR) code is within the field of view.

18. The method of claim 17, further comprising initiating the illumination source in response to the Bluetooth transceiver receiving a signal from a recognizable Device Name in combination with the input signal from the second device.

19. The method of claim 18, further comprising providing the input signal from the second device comprising an accelerometer, an RFID tag, another radiofrequency device, or a manual switch.

20. The method of claim 18, wherein the input signal is provided by an accelerometer indication that a speed of the vehicle is at or above a threshold value.

21. The method of claim 17, further comprising providing power to the initiated illumination source from a power source carried by the vehicle.

22. The marker system of claim 3, wherein the illumination source comprises LEDs arranged below the light-transmissive sheet bearing the augmented reality (AR) code and further comprising a material exhibiting a reflective surface below the LEDs.

23. The marker system of claim 22, wherein at least some of the LEDs are arranged on two or more peripheral sides of the housing between the light-transmissive sheet bearing the AR code and the reflective surface.

24. The marker system of claim 23, wherein the at least some of the LEDs are arranged in linear arrays on sidewalls of the housing and aimed inwardly.
